(19) United States
(12) Patent Application Publication
(10) Pub. No.: US 2006/0053454 A1
(43) Pub. Date: Mar. 9, 2006

(54) Digital broadcast receiving device and method of providing VOD content using the same

(75) Inventor: Dong-hyun Chang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/214,943

(22) Filed: Aug. 31, 2005

(30) Foreign Application Priority Data
Sep. 7, 2004 (KR) 10-2004-71318

(51) Int. Cl. H04N 7/173

(52) U.S. Cl. 725/86; 725/100

(57) ABSTRACT

A method of providing VOD (Video On Demand) content using a digital broadcast receiving device, and a digital broadcast receiving device using the method, the method including receiving broadcast programs and the VOD content through at least one tuner; storing the VOD content received through the at least one tuner; and reproducing the stored VOD content through a specified user authentication procedure.

### CROSS-REFERENCE TO RELATED APPLICATIONS

This application claims the benefit of Korean Patent Application No. 10-2004-0071318, filed on Sep. 7, 2004, in the Korean Intellectual Property Office, the disclosure of which is incorporated herein by reference.

### BACKGROUND OF THE INVENTION

1. Field of the Invention

The present invention relates to a digital broadcast receiving device and a method of providing VOD (Video On Demand) content using the device, and, more particularly, to a digital broadcast receiving device, and a method of providing VOD content, that can provide the VOD content in addition to broadcasting signals.

2. Description of the Related Art

Recently, with the development of digital technology, the era of digital broadcasting, which includes satellite, cable, and ground wave broadcasting, has begun.

Digital broadcasting has become a matter of increasing concern due to its commercial advantages. Several channels, for example, five channels, can be broadcast in one transmission, in comparison to the only one channel that is broadcast in an analog transmission, and high picture quality and diverse functions such as sound, bidirectional services, Internet connections, and others can be provided.

The digital set-top box industry, which produces the devices to receive the digital broadcasts, is growing in the U.S., the Middle East, Europe, and Asia, and is growing larger and larger due to the further development of digital broadcasting.

In the digital broadcasting technology, a digital broadcast receiving device such as a digital set-top box receives and decodes signals containing digital content, which are coded, digitalized, and transmitted by a broadcasting station node, so that a user can view the content through a television receiver (as an analog signal).

FIG. 1 illustrates a conventional digital broadcast receiving device.

As illustrated in FIG. 1, the conventional digital broadcast receiving device includes a tuner 10 to receive a broadcasting signal, a demodulation unit 20 to demodulate the received broadcasting signal, a separation unit 30 to separate a desired signal from the demodulated broadcasting signal, a storage unit 40 to store separated signals, a decoder 50 to decode stored signals, and a control unit 60 to output decoded signals through an output unit 70.

In this case, the signals separated by the separation unit 30 are a video signal, an audio signal, and a data signal included in the broadcasting signal.

The control unit 60 outputs the separated signals through the output unit 70 in real time without storing the signals (depending on the circumstances).

The operation of the conventional digital broadcast receiving device as constructed above will now be explained.

FIG. 2 illustrates an operational method of the conventional digital set top box.

As illustrated in FIG. 2, if a broadcasting signal is received through the tuner 10 S11, the received broadcasting signal is demodulated by the demodulation unit 20 S12.

The demodulated broadcasting signal is separated into a video signal, an audio signal, and a data signal by the separation unit 20 S13, and the separated signals are stored in the storage unit 30 S14.

At this time, if a user requests playback of the stored signal S15, the control unit 60 extracts the signal stored in the storage unit 40 S16.

The extracted signal is decoded by the decoder 50 S17, and the decoded signal is outputted through the output unit 70 S18.

Meanwhile, in the case of outputting the signal separated by the separation unit 30 in real time, the control unit 60 outputs the signal decoded by the decoder 50 through the output unit 70.

Since the above-described digital broadcast receiving device receives and stores general broadcasting signals, and reproduces the stored broadcasting signal according to the user's request, it is difficult for the digital broadcast receiving device to provide discriminative services according to the user's taste.

Accordingly, the development of a digital broadcast receiving device that can provide discriminative services according to the user's taste, in addition to providing general broadcasting signals, is required.

Korean Patent Unexamined Publication No. 2003-0075967 discloses a VOD system that downloads reserved content and stores it in a storage medium by driving a VOD set top box, reproduces the stored content, and charges for the use of the corresponding content. However, this VOD system is limited to the VOD, and thus it is still difficult to provide discriminative services according to the user's taste using general broadcasting signals.

### SUMMARY OF THE INVENTION

An aspect of the present invention is to provide a digital broadcast receiving device, ,and a method of receiving VOD content using the device, which can provide discriminative contents according to the user's taste in addition to general broadcasting signals.

Additional aspects and/or advantages of the invention will be set forth in part in the description which follows and, in part, will be apparent from the description, or may be learned by practice of the invention.

According to an aspect of the present invention, there is provided a digital broadcast receiving device including at least one tuner to receive broadcast programs and VOD (Video On Demand) content, a storage unit to store the VOD content received through the at least one tuner, and a control unit to reproduce the stored VOD content through a specified user authentication process.

According to another aspect of the present invention, there is provided a method of providing VOD (Video On Demand) contents using a digital broadcast receiving device, the method including receiving broadcasting signals and the VOD content through at least one tuner, storing the VOD content received through the at least one tuner, and reproducing the stored VOD content through a specified user authentication process.

According to another aspect of the present invention, there is provided a digital broadcast receiving device including a control unit to control the broadcast receiving device to receive VOD content without being prompted by a user, and a storage unit to store the VOD content.

The control unit may determine the VOD content to be received according to one or more content attributes associated with the user. The content attributes may be determined by the control unit according to VOD content previously selected, and/or other broadcast programs previously viewed, by the user. The content attributes may be input by the user, and may include at least one of subject matter, genre, featured actors, or a combination thereof.

The control unit may control a display to notify the user of any associated cost of viewing the VOD content before controlling the stored VOD content to be displayed.

According to another aspect of the present invention, there is provided a method of providing VOD content using a digital broadcast receiving device, the method including receiving the VOD content without being prompted by a user, and storing the VOD content.

### BRIEF DESCRIPTION OF THE DRAWINGS

These and/or other aspects and advantages of the invention will be apparent and more readily appreciated from the following description of the embodiments, taken in conjunction with the accompanying drawings of which:

FIG. 1 is a block diagram illustrating the construction of a conventional digital broadcast receiving device;

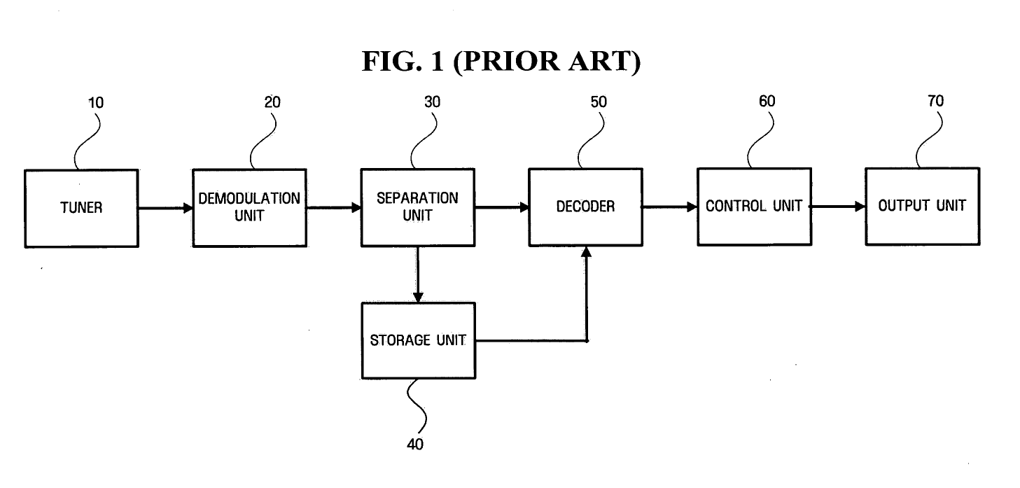

FIG. 2 is a flowchart illustrating the operation of the conventional digital broadcast receiving device;

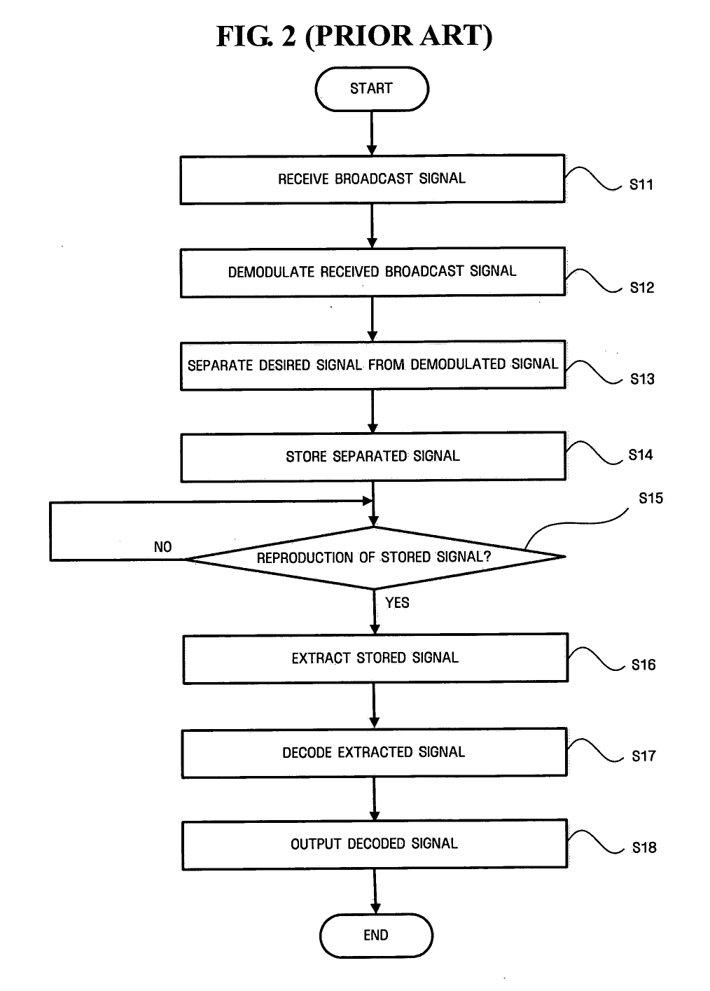

FIG. 3 is a block diagram illustrating the construction of a digital broadcast receiving device according to an embodiment of the present invention;

FIG. 4 is a view illustrating a server that provides broadcast programs and VOD content to the digital broadcast receiving device according to an embodiment of the present invention;

FIG. 5 is a flowchart illustrating a method of providing VOD content using the digital broadcast receiving device according to an embodiment of the present invention; and

FIG. 6 is a flowchart illustrating a method of storing the received broadcast programs and VOD content according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

However, the present invention is not limited to the embodiments disclosed hereinafter, but may be implemented in various and diverse forms. Some matters may be defined in the description along with a detailed construction, however, these elements are merely provided to assist those of ordinary skill in the art to gain a comprehensive understanding of the invention, and the present invention is defined within the scope of the appended claims. In the description of the present invention, drawing reference numerals may be repeated to describe repeated elements in different figures.

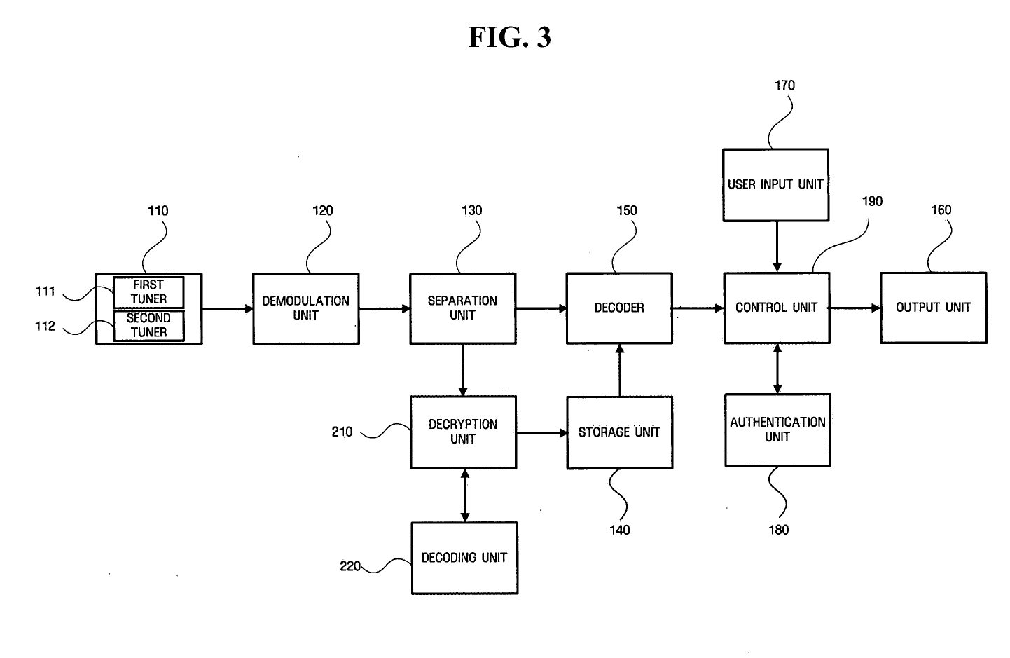

FIG. 3 is a block diagram illustrating the construction of a digital broadcast receiving device according to an embodiment of the present invention.

As illustrated in FIG. 3, the digital broadcast receiving device according to the present invention includes a plurality of tuners 110 to receive broadcast programs and VOD content, a demodulation unit 120 to demodulate the received broadcast programs and VOD content, a separation unit 130 to separate a desired signal from the demodulated broadcast programs and VOD content, a storage unit 140 to store the separated signal, a decoder 150 to decode the stored signal, an output unit 160 to output the decoded signal, a user input unit 170 to input user information in response to the broadcast programs and VOD content being received, an authentication unit 180 to transmit the input user information to a device that provides the broadcast programs and VOD content, and to receive authentication information according to the transmitted user information, and a control unit 190 to reproduce the stored broadcast programs and VOD content according to the received authentication information, and to control the broadcast programs and VOD content storing/reproduction operations .

Additionally, the digital broadcast receiving device may include a decryption unit 210 to decrypt the encrypted broadcast programs and VOD content, and a decoding unit 220 to decode an encrypted key of the broadcast programs and VOD content and to generate a decoded key.

In this case, the tuner 110 may include a first tuner 111 to receive the broadcast programs, and a second tuner 112 to receive the VOD content.

In one embodiment of the present invention, although it is exemplified that the tuner 110 is divided according to the type of received data, a tuner which integrates the first tuner 111 and the second tuner 112 may also be used, depending on the circumstances. In this case, the broadcast programs and VOD content can be selectively received according to pre-designated receiving conditions or a user's selection. Although two tuners are used to receive the broadcast programs and VOD content, the number of tuners can be changed according to the receiving environments.

Additionally, although respective constituent elements 110, 120, 130, 140, 150, 160, 170, 180, 190, 210 and 220 may be used to process the broadcast programs and VOD content received through the first tuner 111 and the second tuner 112, respectively, it is also possible to separate the first tuner 111 and the second tuner 112. Accordingly, the same constituent elements may be used to process the broadcast programs and VOD content received through the first tuner 111 and the second tuner 112, and it should be noted that they can be separately constructed.

Further, the broadcast programs and VOD content received through the first tuner 111 and the second tuner 112 can be received through transmissions from a satellite, cable, ground wave, and/or other modes of transmission.

The demodulation unit 120 can demodulate the broadcast programs and VOD content received through the first tuner 111 and the second tuner 112 into a digital transport stream of a low-frequency band. Also, the demodulated transport stream may be separated from a PES (Packetized Elementary Stream), which is a kind of broadcasting channel, by the separation unit 130.

The broadcast programs and the VOD content can be stored in the storage unit 140. In this case, if the broadcast programs and VOD content are encrypted, they may be stored as they are, or after they are decrypted.

In the case where the encrypted broadcast programs and VOD content are stored after they are decrypted, the decryption unit 210 can decrypt the encrypted broadcast programs and VOD content through a key generated by the decoding unit 220. The decoding unit 220 may be a CAM (Conditional Access Module) that is inserted into a PCMCIA slot; that is, a smart card.

In the case in which paid broadcast programs and VOD content are reproduced, the authentication unit 180 may perform a user authentication procedure through which the corresponding broadcast programs and VOD content can be reproduced.

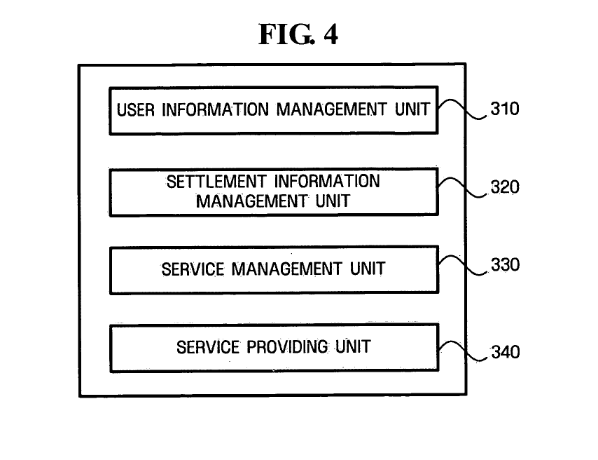

FIG. 4 illustrates a server that provides broadcast programs and VOD content to the digital broadcast receiving device according to an embodiment of the present invention.

As illustrated in FIG. 4, the server may include a user information management unit 310 to generate authentication information according to the user information, a settlement information management unit 320 to manage settlement information if a user uses the paid broadcast programs and VOD content, a service management unit 330 to manage the broadcasting program and VOD content that can be provided, and a service providing unit 340 to provide services such as broadcast programs, VOD content, and others to the user.

The generated authentication information gives a user authority to use the corresponding broadcast programs and VOD content according to the user information such as an ID, password, and others inputted by the user through the user input unit 170, and it may include settlement information and the frequency of use of the broadcast programs and VOD content.

Accordingly, the user information management unit 310 can generate the authentication information using the user information and the settlement information from the settlement information management unit 320, and transmit the use authority to the device that requested it.

The service management unit 330 can generate a list of broadcast programs and VOD content that can be provided.

This list may include a schedule to provide the corresponding broadcast programs and VOD content, and the user can select a desired broadcast program and VOD content through the list.

In one embodiment of the present invention, the schedule indicating the broadcast programs and VOD content which may be provided from the server for a specified period is provided to the user in the same manner as the general VOD service, so that the user can download the broadcast programs and VOD content.

The present invention can also be applied to broadcast programs and VOD content provided from a broadcasting station in real time in the same manner as general broadcast programs.

Accordingly, the control unit can determine the reproduction of the broadcast program and VOD content that the user intends to reproduce by confirming the frequency of use, settlement information, and others included in the received authentication information.

This authentication procedure may be performed when the stored broadcast programs and VOD content are reproduced, or when the broadcast programs and VOD content are initially received.

If data of the broadcast programs and VOD content to be stored exceeds the capacity of the storage unit 140, the control unit may delete the previously stored broadcast programs and VOD content according to the pre-designated priority.

In this case, the broadcast programs and VOD content designated by a label such as “no deletion” by the user are excluded from being deleted.

Also, if the user's input to switch to a channel set by the user is not made in a specified time, the controller 190 automatically switches to the set channel, so that the receiving and storing of the selected broadcast programs and VOD content can be achieved.

Now, a method of receiving VOD content using the digital broadcast receiving device according to an embodiment of the present invention will be explained.

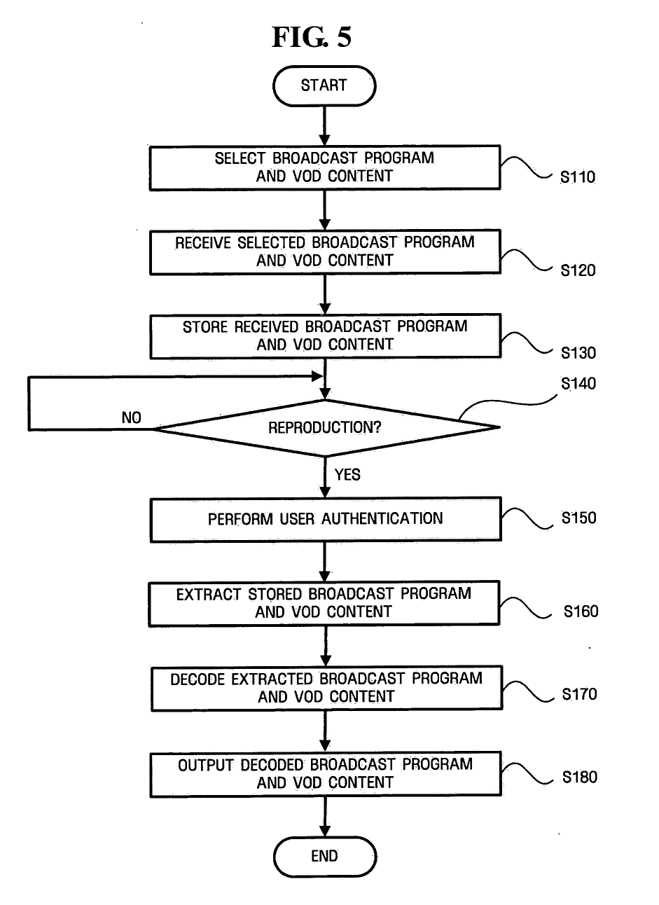

FIG. 5 is a flowchart illustrating a method of providing VOD content using the digital broadcast receiving device according to an embodiment of the present invention.

As illustrated in FIG. 5, the user first selects the broadcast program and VOD content that (s)he intends to use after accessing the server and confirming the broadcast programs and VOD content being provided S110.

At this time, the server can generate a list of the broadcast programs and VOD content that can be provided, and provides the generated list to the user. Accordingly, the user can select the desired broadcast programs and VOD content from the provided list.

Also, the user can confirm whether the desired broadcast program or VOD content is free or requires fee payment when he/she selects the broadcast program and VOD content.

The selected broadcast program and VOD content are received by the tuner 110 through a transmission from a satellite, ground wave, cable, and/or other modes of transportation S120.

The received broadcast program and VOD content are demodulated into a transmission stream by the demodulation unit 120, and then separated into the corresponding broadcast program and the VOD content by the separation unit 130, so that the separated broadcast program and the VOD content are stored in the storage unit 140 S130.

If the user intends to reproduce the stored broadcast program and VOD content S140, the user may perform the user authentication procedure by accessing the server S150.

In the user authentication procedure, the user can transmit user information such as his/her ID, password, and/or other types of information to the server, and receive the authentication information according to the transmitted user information.

The received authentication information may include the settlement information and the frequency of use of the corresponding broadcast program and VOD content.

The user authentication procedure may be performed in response to the user reproducing the corresponding broadcast program and VOD content after receiving them, or it may be performed before the user receives the corresponding broadcast program and VOD content.

In the case of the paid broadcast program and VOD content, the server can determine whether the user has paid for the broadcast program and VOD content through the user authentication procedure.

Specifically, in the case in which the user authentication procedure is performed after the corresponding broadcasting program and VOD content are received, the server can determine whether the payment for the corresponding broadcast program and VOD content has been made through the user authentication procedure.

At this time, if the user has paid for the corresponding broadcast program and VOD content, the server transmits to the user a reproduction authority for the reproduction of the broadcast program and VOD content stored in the storage unit 140.

In the case in which the user authentication procedure is performed before the corresponding broadcast program and VOD content are received, the server provides the corresponding broadcast program and VOD content only in response to the server confirming that the user has paid for the content through the user authentication procedure.

After the user authentication procedure, the control unit 190 extracts the broadcast program and VOD content stored in the storage unit 140 S160, and the decoder 150 decodes the extracted broadcast program and VOD content S170.

The decoded broadcast program and VOD content are outputted through the output unit 160.

In this case, if the extracted VOD content is encrypted, the decryption unit 210 decrypts the encrypted VOD content using the key generated by the decoding unit 220.

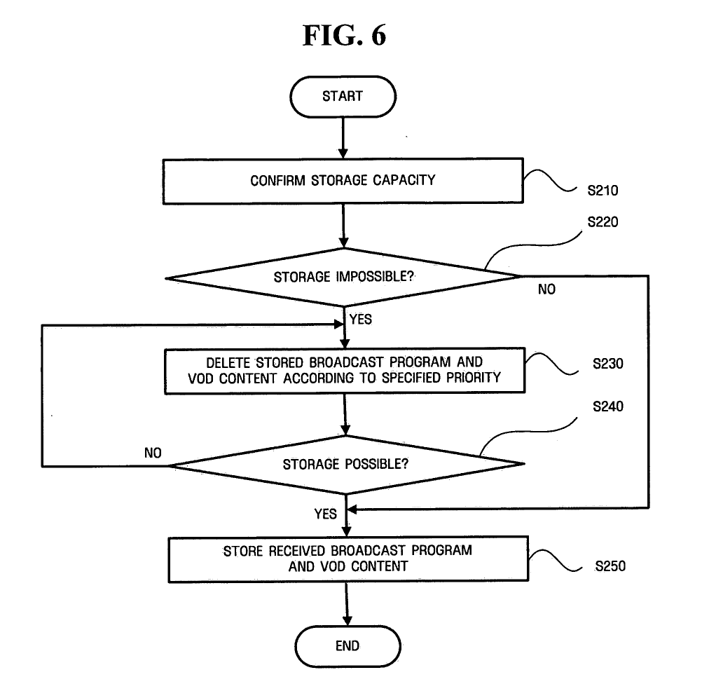

If data of the broadcast program and VOD content to be stored exceeds the capacity of the storage unit 140, the capacity of the storage unit 140 is managed as illustrated in FIG. 6.

As illustrated in FIG. 6, in the case of storing the received broadcast program and VOD content, the control unit 190 confirms the remaining capacity of the storage unit 140 S210.

If the remaining capacity of the storage unit 140 is insufficient to store the corresponding broadcast program and VOD content S220, the control unit 190 deletes one or more previously stored broadcast programs and VOD content according to the pre-designated priority, i.e., the broadcast programs and VOD content having the lowest priority are first deleted S230.

If the capacity for storing the corresponding program and VOD content is secured as a result of the deletion S240 of previously stored broadcast programs and VOD content, the control unit 190 stores the received broadcast program and VOD content in the storage unit 140 S250. If the capacity for storing the corresponding program and VOD content is not secured as a result of the deletion S230 of previously stored broadcast programs and VOD content, additional deletion takes place until the storage capacity is secured S240.

When deleting the pre-stored VOD content according to the priority in order to secure the capacity of the storage unit 140, the broadcast programs and VOD content designated as “no deletion” by the user can be prevented from being deleted.

As described above, according to the digital broadcast receiving device, and the method of receiving VOD content using the device, according to the present invention, VOD can be provided according to the user's taste in addition to general broadcast signals, and thus, the present invention is convenient. The digital broadcast receiving device may receive the VOD content, without being prompted by the user, according to one or more content attributes associated with the user.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A digital broadcast receiving device comprising:
at least one tuner to receive broadcast programs and VOD (Video On Demand) content;
a storage unit to store the VOD content received through the at least one tuner; and
a control unit to reproduce the stored VOD content through a specified user authentication process.

2. The digital broadcast receiving device as claimed in claim 1, further comprising:
a user input unit to input user information; and
an authentication unit to transmit the input user information to a device that provides the broadcast programs and VOD content, and to receive authentication information according to the transmitted user information.

3. The digital broadcast receiving device as claimed in claim 2, wherein the received authentication information includes at least one of settlement information, a number of uses of the corresponding VOD content, or a combination thereof.

4. The digital broadcast receiving device as claimed in claim 3, wherein the tuner comprises:
a first tuner to receive the broadcast programs; and
a second tuner to receive the VOD content.

5. The digital broadcast receiving device as claimed in claim 4, wherein the control unit deletes at least a portion of previously stored VOD content according to a pre-designated priority in response to the received VOD content exceeding an available capacity of the storage unit.

6. A method of providing VOD (Video On Demand) content using a digital broadcast receiving device, the method comprising:
receiving broadcast programs and the VOD content through at least one tuner;
storing the VOD content received through the at least one tuner; and
reproducing the stored VOD content through a specified user authentication process.

7. The method as claimed in claim 6, wherein the tuner comprises:
a first tuner to receive the broadcast programs; and
a second tuner to receive the VOD content.

8. The method as claimed in claim 7, wherein the storing the received VOD content comprises deleting at least a portion of previously stored VOD content according to a pre-designated priority in response to an available storage capacity being insufficient to store the received VOD content.

9. The method as claimed in claim 8, wherein the user authentication procedure comprises:
a user inputting user information; and
transmitting the input user information to device that provides the broadcast programs and VOD content, and receiving authentication information according to the transmitted user information.

10. The method as claimed in claim 9, wherein the received authentication information includes at least one of settlement information, a number of uses of the corresponding VOD content, or a combination thereof.

11. A digital broadcast receiving device comprising:
a control unit to control the broadcast receiving device to receive VOD (Video On Demand) content without being prompted by a user; and
a storage unit to store the VOD content.

12. The digital broadcast receiving device of claim 11, wherein the control unit determines the VOD content to be received according to one or more content attributes associated with the user.

13. The digital broadcast receiving device of claim 12, wherein the content attributes are determined by the control unit according to VOD content previously selected, and/or other broadcast programs previously viewed, by the user.

14. The digital broadcast receiving device of claim 12, wherein the content attributes are input by the user.

15. The digital broadcast receiving device of claim 12, wherein the content attributes include at least one of subject matter, genre, featured actors, or a combination thereof.

16. The digital broadcast receiving device of claim 11, further comprising:
a user input to input user information; and
an authentication unit to transmit the input user information to a provider of the VOD content, and to accordingly receive authentication information in order to display the VOD content.

17. The digital broadcast receiving device of claim 11, wherein the control unit controls a display to notify the user of any associated cost of viewing the VOD content before controlling the stored VOD content to be displayed.

18. The digital broadcast receiving device of claim 11, wherein the VOD content is received through transmission from one of a satellite, cable, ground wave, or a combination thereof.

19. The digital broadcast receiving device of claim 11, further comprising:
a first tuner to receive the VOD content; and
a second tuner to receive other broadcast programs.

20. A method of providing VOD (Video On Demand) content using a digital broadcast receiving device, the method comprising:
receiving the VOD content without being prompted by a user; and
storing the VOD content.

21. The method of claim 20, further comprising determining the VOD content to be received according to one or more content attributes associated with the user.

22. The method of claim 21, wherein the content attributes are determined according to VOD content previously selected, and/or other broadcast programs previously viewed, by the user.

23. The method of claim 21, wherein the content attributes are input by the user.

24. The method of claim 21, wherein the content attributes include at least one of subject matter, genre, featured actors, or a combination thereof.

25. The method of claim 20, further comprising:
receiving user information from a user; and
transmitting the user information to a provider of the VOD content, and accordingly receiving authentication information in order to display the VOD content.

26. The method of claim 20, further comprising notifying the user of any associated cost of viewing the VOD content before displaying the stored VOD content to the user.

27. The method of claim 20, further comprising receiving the VOD content through transmission from one of a satellite, cable, ground wave, or a combination thereof.

28. The method of claim 20, further comprising:
receiving the VOD content through a first tuner; and
receiving other broadcast programs through a second tuner.
